(19) United States
(12) Patent Application Publication
(10) Pub. No.: US 2023/0033714 A1
(43) Pub. Date: Feb. 2, 2023

(54) METHOD AND SYSTEM FOR SECURELY TRANSMITTING FILE VIA REMOTE BROWSER

(71) Applicant: SOFTCAMP CO., LTD., Gyeonggi-do (KR)

(72) Inventor: Hwan-Kuk BAE, Gyeonggi-do (KR)

(21) Appl. No.: 17/878,251

(22) Filed: Aug. 1, 2022

(30) Foreign Application Priority Data
Jul. 30, 2021 (KR) 10-2021-0100611

(51) Int. Cl. G06F 21/56; G06F 21/53

(52) U.S. Cl. CPC G06F 21/568; G06F 21/53

(57) ABSTRACT

A method and system for securely transmitting a file via a remote browser, where method includes: a first step of connecting to a client web browser accessing a designated Internet Protocol (IP) address, and setting a relay environment between a service server of the designated IP address and a client terminal; a second step of constructing a sandbox with respect to the client web browser, and executing a web page constructed in the website of the service server in the sandbox; a third step of extracting the rendering screen of the web page from the sandbox, and transmitting rendering screen information so that the rendering screen is displayed on the client web browser; and a fourth step of receiving first input information about the rendering screen information from the sandbox, and generating and transmitting second input information corresponding to the first input information.

### CROSS-REFERENCE

This application claims the benefit of Korean Patent Application No. 10-2021-0100611 filed on Jul. 30, 2021, which is hereby incorporated by reference herein in its entirety.

### BACKGROUND

The present invention relates to a method and system for securely transmitting a file via a remote browser that implement secure communication between a client and a server.

With the development of the Internet and network-related communication technologies, individuals can freely acquire or deliver various types of information in an Internet environment, and various companies and government offices can share various information materials over the Internet even when they are located far away from each other. In this environment, individuals can receive non-face-to-face services such as civil complaint handling services and financial services from public offices or financial institutions.

However, as the acquisition, delivery, and sharing of information over a network are performed freely, cases of the illegitimate divulgence of personal information attributable to various types of malicious code as well as cases of the illegitimate divulgence of the important information of companies, government offices, and/or the like in the process of providing important information to unspecified individuals have increased rapidly. Furthermore, in the case where non-face-to-face services are provided, the service of a server is exposed to the outside, and is thus vulnerable to malicious attacks. When the server is infected with malicious code, a problem arises in that the service of the server needs to be stopped to prevent the spread of the malicious code. Therefore, there is a need for technology for security against malicious code that can provide the protection of information and safety in a network.

In general, malicious code is software designed to perform malicious activities against a user's will in a computer system, and may be classified as a virus, a worm, a Trojan horse, or the like depending on its self-replication ability and the presence of an infection target. As the amount of malicious code is increasing rapidly compared to that in the past, the need for the effective diagnosis and treatment of malicious code is also increasing.

As part of the technology for diagnosing and treating malicious code, Korean Patent Application Publication No. 10-2009-0005933 (published on Jan. 14, 2009) discloses a technology for modeling the behavior of a specific computer program so that it can be determined whether the specific computer program is malicious by using the behavior of the specific computer program. However, in this related art, in order to put the behavioral patterns of the programs of known types of malicious code into a database, data on the malicious programs is collected through reports of victims who have suffered from damage, and additional damage is prevented only after that. Accordingly, problems arise in that a certain number of victims are bound to occur until a report of the victim is received and it is impossible to diagnose and treat malicious code exhibiting a new pattern.

Recently, as the security awareness of companies and individuals has increased, the success rate of existing malicious threats in the form of executable files is decreasing. However, attackers are attempting intelligent attacks in unknown ways in order to neutralize or bypass the security environment of the conventional art. In general, the attacks are intended to insert malicious code into document files by using the vulnerability of the files such as document files such as Microsoft Office series files, Hangul series files, PDF files, etc. (hereinafter referred to as “document files”). In particular, attacks through document files easily cause threats because document files themselves are frequently used in business, and thus recipients may download or execute the document files without doubt. In general, when a corresponding function is executed using a basic function of the document file format such as macro, JavaScript, or the like, malicious code is downloaded over an external link, so that there are cases where a document file does not contain malicious code. Accordingly, in the security environment that detects malicious threats based on known types of malicious code, there are limitations to the detection of malicious code.

In addition, a sandbox-based behavior analysis security technology can analyze suspicious behavior only when a document file containing malicious code is executed at least once. Accordingly, it is difficult for the sandbox-based behavior analysis security technology to prevent zero-day attacks, ransomware attacks, etc. Moreover, since malicious code is executed in a specific event or bypass methods such as delayed execution are continuously appearing, the problems of the existing security environment, which performs defense based on known types of malicious code, are continuously pointed out.

### SUMMARY OF THE INVENTION

The present invention has been conceived to overcome the above-described problems, and an object of the present invention is to provide a method and system for securely transmitting a file via a remote browser that can prevent the illegitimate divulgence of information over the Internet and strengthen the security of an information providing service server.

According to an aspect of the present invention, there is provided a method for securely transmitting a file via a remote browser, the method including: a first step of connecting, by a remote browsing server, to a client web browser accessing a designated Internet Protocol (IP) address, and setting, by the remote browsing server, a relay environment between a service server of the designated IP address and a client terminal; a second step of constructing, by the remote browsing server, a sandbox having a virtual web browsing function with respect to the client web browser, and executing, by the remote browsing server, a web page constructed in the website of the service server in the sandbox; a third step of extracting the rendering screen of the web page from the sandbox, and transmitting rendering screen information so that the rendering screen is displayed on the client web browser; and a fourth step of receiving first input information about the rendering screen information from the sandbox, and generating and transmitting second input information corresponding to the first input information.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram schematically showing the network communication configuration of a transmission system according to the present invention;

FIG. 2 is a block diagram showing the remote browsing server of the transmission system according to the present invention in conjunction with another communication object;

FIG. 3 is a flowchart sequentially showing a transmission method based on the transmission system according to the present invention; and

FIG. 4 is a diagram schematically showing a web page screen of a service server that is displayed when a client terminal of the transmission system according to the present invention accesses the remote browsing server.

### DETAILED DESCRIPTION OF THE INVENTION

Currently widely used general terms are selected as the terms used in the following embodiments as much as possible while considering the functions of the terms used in the present invention, but may vary depending on the intention of a person of ordinary skill in the art, a precedent, the emergence of a new technology, and/or the like. In addition, in one or more specific cases, there may be one or more terms selected by the present applicant as desired, in which cases the meanings thereof will be described in detail in the corresponding portions of the detailed description of the invention. Accordingly, the terms used herein should be defined based on the meanings and overall content of the terms throughout the present invention, rather than the simple names thereof.

Throughout the overall specification, when a part is described as “including” a component, it means that the part may further include another component, rather than excluding another component, unless otherwise stated. Furthermore, the term “unit” refers to a component unit within which at least one function or operation is processed, which may be implemented as hardware, software, or a combination of hardware and software.

Hereinafter, embodiments of the present invention will be described in detail with reference to the accompanying drawings so that those of ordinary skill in the art to which the present invention pertains can easily practice the present invention. However, the present invention may be implemented in various different forms, and is not limited to the embodiments described herein.

The embodiments of the present invention will be described in detail below with reference to the accompanying drawings.

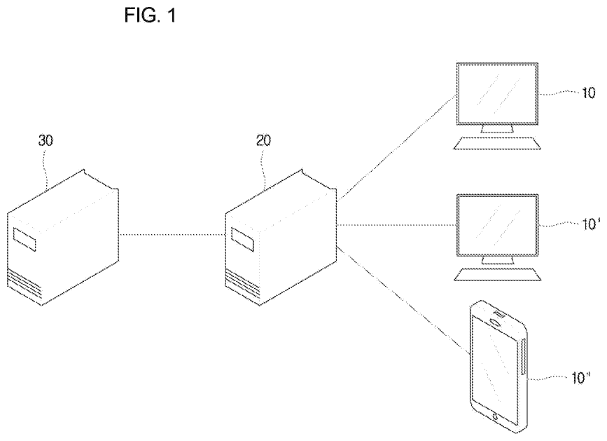

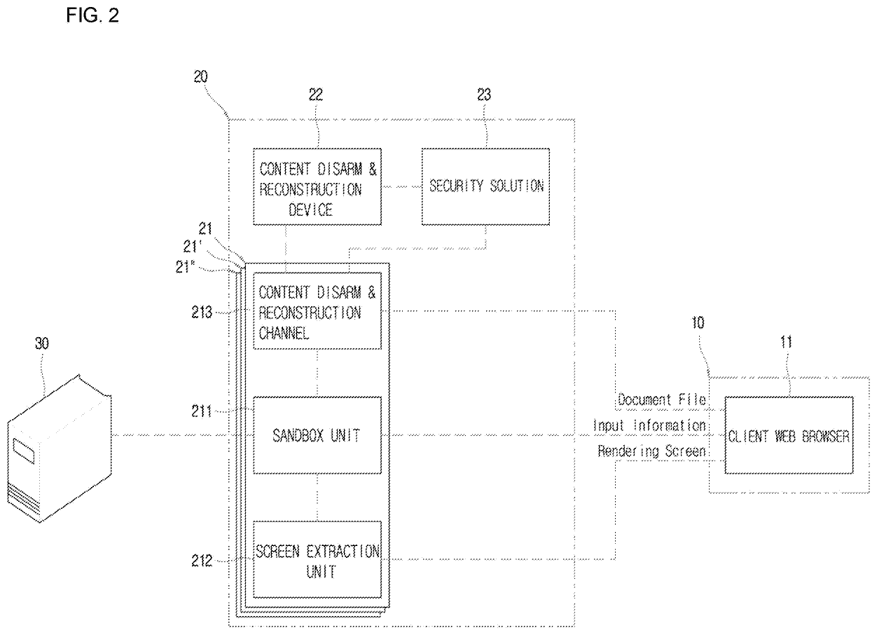

FIG. 1 is a diagram schematically showing the network communication configuration of a transmission system according to the present invention, and FIG. 2 is a block diagram showing the remote browsing server 20 of the transmission system according to the present invention in conjunction with another communication object.

Referring to FIGS. 1 and 2, the transmission system according to the present invention includes the remote browsing server 20 configured to relay the communication between client terminals 10, 10′, and 10″ (hereinafter referred to as “10”) and a service server 30 and to perform a security process. In greater detail, the remote browsing server 20 performs the virtual web browsing function of connecting to and executing the website of the service server 30 on behalf of the client web browser 11 of the client terminal 10, extracts a rendering screen from an executed web page of the website, and transmits the rendering screen to the client terminal 10. Furthermore, the remote browsing server 20 removes the malicious code of a document file transmitted from the client terminal 10, and transmits the malicious code-free document file to the service server 30.

To this end, the remote browsing server 20 sets relay environments 21, 21′, and 21″ (hereinafter referred to as “21”) configured to perform a primary security process via a virtual web browsing function, and further includes a content disarm & reconstruction device 22 configured to perform a secondary security process to remove malicious code. Furthermore, the remote browsing server 20 may further include a security solution 23 configured to detect and neutralize malicious code, such as a vaccine program, in addition to the content disarm & reconstruction device 22. For reference, each of the relay environments 21 is a process that is activated by the remote browsing server 20 during the relay of the communication between the service server 30 and the client web browser 11.

Each of the relay environments 21 set by the remote browsing server 20 prevents the direct exposure of the website to the client terminal 10 for the security of the service server 30, and also performs a virtual web browsing function to realize the full browsing of web pages constructed in the website in the client web browser 11 of the client terminal 10. The relay environment 21 establishes a channel so that the communication between the client web browser 11 and the website of the service server 30 is performed only through the remote browsing server 20. The multiple relay environments 21 are constructed for the same client web browser 11, so that the same client web browser 11 can indirectly communicate with the website of the service server 30 over various channels in the remote browsing server 20.

The components of the remote browsing server 20 will be described in greater detail below. In the set relay environment 21, a sandbox unit 211 and a screen extraction unit 212 are activated, and a content disarm & reconstruction channel 213 configured to transmit a document file, uploaded from the client web browser 11, to the content disarm & reconstruction device 22 is activated. The sandbox unit 211 constructs a sandbox for a virtual web browsing function, and the screen extraction unit 212 extracts the rendering screen of a web page from the sandbox. Meanwhile, a document file delivered over the content disarm & reconstruction channel 213 is recombined by the content disarm & reconstruction device 22, and thus various types of malicious code are neutralized. Since a content disarm & reconstruction process performed by the content disarm & reconstruction device 22 is performed through a known content disarm & reconstruction (CDR) algorithm, detailed technical descriptions of the algorithm of the content disarm & reconstruction device 22 and other security processes will be omitted. For reference, the sandbox is an isolated space that is constructed for security when any program or code is executed on a computer. When the sandbox is executed, a non-permitted process cannot be performed in a space other than a designated space. For example, JavaScript code executed on a web browser operates only within a scope permitted by the web browser, and cannot affect a computer environment outside the web browser. Flash files are the above type of examples.

Meanwhile, the security solution 23 removes or neutralizes malicious code by changing the code, like a known vaccine program. The security solution 23 may secondarily perform security processing on a document file processed by the content disarm & reconstruction device 22, or may perform security processing on a document file prior to the performance of the content disarm & reconstruction device 22 and then deliver the document file to the content disarm & reconstruction device 22. Since the security solution 23 is a well-known technology like the content disarm & reconstruction device 22, detailed technical descriptions of the algorithm of the security solution 23 and other security processes will be omitted.

Meanwhile, as described above, the remote browsing server 20 sets multiple relay environments 21, thereby flexibly distributing the communication load between the remote browsing server 20 and the client web browser 11 and also performing a failover function in case of emergency. A plurality of relay environments 21 may be set for the same web page, or may be constructed separately for respective web pages constructed in the website, so that corresponding rendering screen information is rapidly transmitted in response to a web page change request from the client web browser 11. In the former case, an advantage arises in that the failover function is stably performed, whereas in the latter case, an advantage arises in that the communication load is flexibly distributed.

A transmission method based on the above-described transmission system according to the present invention will be described below.

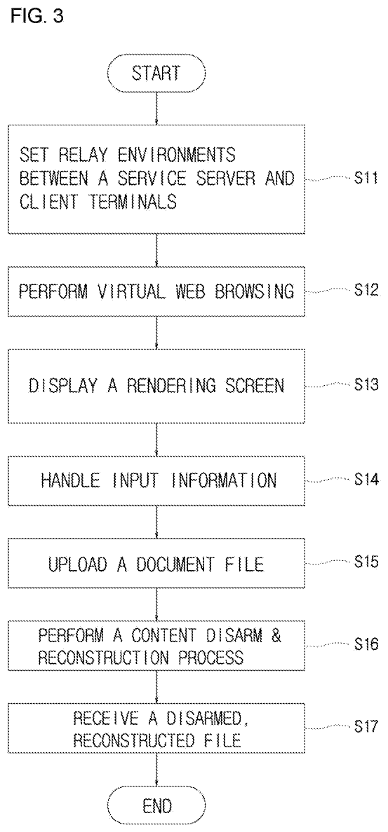

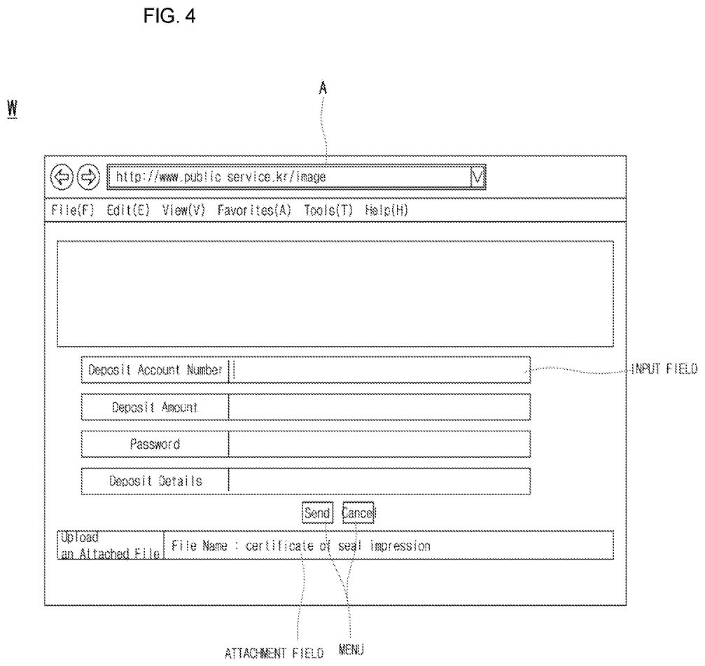

FIG. 3 is a flowchart sequentially showing a transmission method based on the transmission system according to the present invention, and FIG. 4 is a diagram schematically showing a web page screen of the service server that is displayed when the client terminal of the transmission system according to the present invention accesses the remote browsing server.

Referring to FIGS. 1 to 4, the transmission method according to the present invention includes: the step of setting, by the remote browsing server 20, the relay environments 21 between the service server 30 and the client terminals 10; the virtual web browsing step of constructing, by the sandbox unit 211 activated in one of the relay environments 21, a sandbox, and accessing and executing the website of the service server 30 through the sandbox; the rendering screen display step of extracting a web page W, executed in the virtual web browsing step, as a rendering screen; the input information handling step of receiving and checking input information of the client terminal 10 and executing a website; the document file upload step of checking a document file uploaded by the client web browser 11; the content disarm & reconstruction step of disarming and reconstructing the document file; and the disarmed, reconstructed document file reception step of delivering, by the remote browsing server 20, the disarmed, reconstructed document file to the website, and checking, by the service server 30, the disarmed, reconstructed document file.

Each of the above-described steps will be described in more detail below.

S11: Step of setting relay environments between the service server and the client terminals

The remote browsing server 20 connects to the client web browser 11 accessing a designated Internet Protocol (IP) address, and sets relay environments between the service server 30 having the designated IP address and the client terminals 10. In this case, the designated IP address corresponds to the website of the service server 30 according to the present embodiment. The website may be the website of a server that is operated by a general government office, a company, or an individual.

When the client web browser 11 attempts to connect to or connects to a designated IP address, i.e., a specific website, the connection is switched to the remote browsing server 20. Accordingly, the client web browser 11 communicates with the remote browsing server 20 thereafter.

Each of the relay environments 21 is a relay process that relays the communication between the service server 30 and the client web browser 11. When the communication with the client web browser 11 is stopped, the relay environment 21 is stopped and log data is deleted. In the set relay environment 21, the sandbox unit 211 and the screen extraction unit 212 are constructed, and, if necessary, the content disarm & reconstruction channel 213 that is a communication route with the content disarm & reconstruction device 22 is constructed. The multiple relay environments 21, 21′, and 21′ may be constructed for the client web browser 11. Since this has been described above, a further description thereof will be omitted.

S12: Virtual Web Browsing Step

The remote browsing server 20 constructs a sandbox having a virtual web browsing function with respect to the client web browser 11, and executes a web page W, constructed in the website of the service server 30, in the sandbox. More specifically, the sandbox unit 211 of the relay environment 21 constructs a sandbox that replaces the function of the client web browser 11 as a virtual web browser that accesses the website of the service server 30. In the sandbox, the processing of the website is performed only within a defined range. Accordingly, data communication with the website and the execution of data received from the website are performed only within the range of the sandbox, and cooperative operation with other programs not specified by the sandbox unit 211 other than the sandbox is prohibited.

S13: Rendering Screen Display Step

The rendering screen of the web page W is extracted from the sandbox, and rendering screen information is transmitted such that the rendering screen is displayed in the client web browser 11. As described above, in the remote browsing server 20, the web page screen W of the website is executed in the sandbox that performs a virtual web browsing function, so that the screen extraction unit 212 of the relay environment 21 extracts information about the screen by rendering the corresponding web page W. In greater detail, the screen extraction unit 212 identifies the source code of the web page W received in the sandbox, extracts the screen shape of the web page W based on a technology such as HTML, CSS, JavaScript, or the like, generates only the image of the screen shape as a rendering screen, and extracts the rendering screen as information. In this case, the information of the rendering screen consists only of image information for display, and link information and other types of code information operating in conjunction with another program of the client terminal 10 are excluded. However, in the case of a menu or input box selected by a client on the screen of the web page W, a menu key and an input key are included in the information of the rendering screen.

The information of the rendering screen is transmitted to the client web browser 11, and the client web browser 11 of the client terminal 10 reads the information of the rendering screen and displays a corresponding image. Since the rendering screen output to the client web browser 11 is not the original web page W, an indication A informing a client that the output rendering screen is not the original web page W is displayed in a URL display field in the present embodiment. Alternatively, the corresponding indication A may be formed at a specific location of the web page W, or the corresponding indication A may not be formed in the web page W.

Thereafter, the client checks the displayed screen of the web page W, i.e., the rendering screen, and acquires information provided by the website of the service server 30.

S14: Input Information Handling Step

First input information about the information of a rendering screen is received from the sandbox, and second input information corresponding to the first input information is generated and transmitted. When the rendering screen of the web page W is displayed as an image on the client terminal 10 through the execution of the client web browser 11 by the client, a client acquires information while checking the displayed rendering screen, and selects a menu or input box on the rendering screen. When the menu or input box is selected, a corresponding menu key or input key is activated, and first input information generated through the activation is transmitted to the remote browsing server 20 and received in the sandbox.

The first input information is analyzed in the sandbox based on the information of the corresponding web page W, is generated as second input information, and is transmitted to the service server 30. Since the service server 30 recognizes the second input information as response information or input information generated by general data communication between a website and the client web browser 11, the service server 30 transmits the information of the corresponding web page W, which is a result value corresponding to the second input information, to the remote browsing server 20 according to a preset process. Thereafter, the remote browsing server 20 repeats the subsequent process starting from step S13 of displaying the rendering screen. For reference, the first input information may be the personal information of a user (the client).

S15: Document File Upload Step

The remote browsing server 20 receives a document file from the client web browser 11. A specific web page W may contain content that requests a document file from a client. In response to this request, the client may attach the document file to an attachment field with good or malicious intent and upload the attached document file.

As described above, since an image of the web page W output to the client web browser 11 is the rendering screen, the document file input into the attachment field is transmitted to the content disarm & reconstruction channel 213, other than the sandbox. The content disarm & reconstruction channel 213 delivers the document file to the content disarm & reconstruction device 22 constructed in the remote browsing server 20.

S16: Content Disarm & Reconstruction Step

The document file is disarmed and reconstructed through file format conversion and restoration. A content disarm & reconstruction process is performed by the content disarm & reconstruction device 22. Since a content disarm & reconstruction algorithm executed by the content disarm & reconstruction device 22 is a known CDR technology as described above, a detailed description of the content disarm & reconstruction process will be omitted.

Meanwhile, the remote browsing server 20 further includes the security solution 23 configured to provide additional security in addition to the content disarm & reconstruction device 22. The security solution 23 may be a vaccine program that detects and neutralizes malicious code, with which the document file is infected, in parallel with the content disarm & reconstruction device 22. The security process of the security solution 23 may be performed before or after the content disarm & reconstruction process of the content disarm & reconstruction device 22. When all processes such as content disarm & reconstruction and the neutralization of malicious code are completed, the following disarmed, reconstructed file receiving step S17 is performed.

S17: Disarmed, Reconstructed File Reception Step

When the content disarm & reconstruction of the document file is completed via the content disarm & reconstruction device 22, the corresponding document file is delivered to the sandbox over the content disarm & reconstruction channel 213, and the disarmed, reconstructed document file is transmitted to the service server 30 along the communication path of a corresponding web page executed in the sandbox. As a result, since the service server 30 receives the requested document file from the client terminal 10, it recognizes the document file as a document file attached by the client to the attachment field of the web page, and performs a subsequent process. In addition, the service server 30 transmits another piece of web page information, i.e., a corresponding result value, to the remote browsing server 20 so that the client can check an upload result.

Thereafter, the remote browsing server 20 repeats a subsequent process starting from step S13 of displaying the rendering screen.

Since the remote browsing server 20 relays the communication between the service server 30 and the client terminals 10 through the above-described process, the exposure of the service server 30 to unspecified client terminals 10 may be minimized, and the spread of malicious code with which the document file is infected may be blocked. In addition, the infection of the client terminals 10 may be prevented by blocking the spread of malicious code.

The present invention secures an uploaded document file and also minimizes the exposure of the service server to unspecified client terminals by relaying the communication between the client terminals and the service server, thereby preventing the spread of malicious code and protecting not only personal information but also information requiring security.

Although the present invention has been described with reference to the preferred embodiments of the present invention in the foregoing detailed description of the present invention, it will be easily understood by those of ordinary skill in the art to which the present invention pertains that various modifications and alterations may be made to the present invention without departing from the spirit and technical scope of the present invention described in the claims to be described later.

What is claimed is:

1. A method for securely transmitting a file via a remote browser, the method comprising:
a first step of connecting, by a remote browsing server, to a client web browser accessing a designated Internet Protocol (IP) address, and setting, by the remote browsing server, a relay environment between a service server of the designated IP address and a client terminal;
a second step of constructing, by the remote browsing server, a sandbox having a virtual web browsing function with respect to the client web browser, and executing, by the remote browsing server, a web page constructed in a website of the service server in the sandbox;
a third step of extracting a rendering screen of the web page from the sandbox, and transmitting rendering screen information so that the rendering screen is displayed on the client web browser; and
a fourth step of receiving first input information about the rendering screen information from the sandbox, and generating and transmitting second input information corresponding to the first input information.

2. The method of claim 1, further comprising, after the fourth step:
a fifth step of receiving, by the remote browsing server, a document file from the client terminal;
a sixth step of disarming and reconstructing the document file through file format conversion and restoration; and
a seventh step of transmitting the disarmed, reconstructed document file to a service server along a communication path of the corresponding web page executed in the sandbox.

3. The method of claim 2, further comprising, after the fifth step and before the seventh step, a step of checking whether the document file is infected with malicious code via a security program.

4. The method of claim 1, wherein the relay environment set by the remote browsing server to perform construction of a sandbox and extraction of a rendering screen comprises multiple relay environments that are constructed between the client web browser and the service server.
